(19) United States
(12) Patent Application Publication
(10) Pub. No.: US 2012/0119544 A1
(43) Pub. Date: May 17, 2012

(54) CAR BODY WITH REINFORCING STRUCTURE

(75) Inventors: Udo MILDNER, Limburg (DE); Stanislaw KLIMEK, Frankfurt/Main (DE)

(73) Assignee: GM GLOBAL TECHNOLOGY OPERATIONS LLC, Detroit, MI (US)

(21) Appl. No.: 13/293,197

(22) Filed: Nov. 10, 2011

(30) Foreign Application Priority Data
Nov. 12, 2010 (DE) 102010051256.7

(51) Int. Cl. B62D 25/00

(52) U.S. Cl. 296/193.07

(57) ABSTRACT

A car body is provided with a longitudinal beam structure that extends in essentially the longitudinal direction of the vehicle, a front longitudinal beam, a rear longitudinal beam, and an intermediate piece that structurally connects the rear longitudinal beam to the front longitudinal beam. The longitudinal beam structure is connected to a reinforcing structure that bridges the intermediate piece and, referred to in the lateral direction of the vehicle, is arranged laterally offset to the longitudinal beam structure at least in certain areas.

### CROSS-REFERENCE TO RELATED APPLICATION

This application claims priority to German Patent Application No. 102010051256.7, filed Nov. 12, 2010, which is incorporated herein by reference in its entirety.

### TECHNICAL FIELD

The technical field pertains to a car body, particularly a car body front section with structure, reinforcement in the transition area between a front frame and the vehicle dashboard.

### BACKGROUND

Integral car bodies typically feature a front frame that, referred to the driving direction of the motor vehicle, is arranged in front of the passenger compartment and has lateral front longitudinal beams that extend essentially in the longitudinal direction of the vehicle. In the region of a dashboard that separates the passenger compartment from the engine compartment arranged in front thereof, the longitudinal beams are structurally connected, i.e., connected in a load-transmitting fashion, to a dashboard cross member, a lateral dashboard sheet and/or lateral sill boards that extend in essentially the longitudinal direction of the vehicle.

A wheel housing with a wheel housing sheet or wheel arch sheet is furthermore provided in the aforementioned transition area. The wheel housing is typically curved inward. In order to structurally reinforce the front frame connection, it is typically required to provide a reinforcing structure, e.g., in the form of a reinforcing sheet that is adapted to the contour of the wheel arch or the dashboard sheet.

For example, DE 60 2005 003 418 T2 discloses a front frame of a car body, the rear end of which is designed in such a way that it is arranged rearward of lateral sill boards referred to each front end. In this case, a rear end region of the front frame, a front end region of the corresponding lateral sill boards and a front end region of the corresponding floor frame are connected into a torque box that serves as a reinforcing component.

In contrast, at least one objective is to improve the structural rigidity of a car body, particularly in the transition area between the front frame and the dashboard, and of increasing its resistance, in particular, to forces acting thereupon laterally and/or in the longitudinal direction of the vehicle. At least another objective is minimizing the overall weight of the car body and improving the structural rigidity of the car body in the lateral direction of the vehicle, as well as the intrusion behavior of the car body during a lateral impact.

### SUMMARY

The car body has at least one longitudinal beam structure that extends in essentially the longitudinal direction (x) of the vehicle and features at least one front longitudinal beam, one rear longitudinal beam and an intermediate piece that structurally connects the rear longitudinal beam to the front longitudinal beam. In this case, the intermediate piece may furthermore act as a component of a front frame extension, particularly if the front longitudinal beam is realized in the form of a component of a front frame that is arranged, for example, in the engine compartment.

The front longitudinal beam transforms into the intermediate piece, particularly in a connecting region to a vehicle dashboard, and the intermediate piece in turn transforms into the rear longitudinal beam at about the B-column of the car body. This longitudinal beam structure extends in essentially the longitudinal direction of the vehicle and therefore features three beam sections that are respectively arranged in succession referred to the longitudinal direction of the vehicle and structurally connected to one another, namely the front longitudinal beam, the intermediate piece and the rear longitudinal beam.

In order to increase the structural and torsional rigidity of the longitudinal beam structure and to improve the lateral intrusion behavior of the beam structure, particularly during a lateral impact, the longitudinal beam structure is connected to a reinforcing structure that bridges the intermediate piece. Referred to the lateral direction (y) of the vehicle, the reinforcing structure is in this case arranged laterally offset to the longitudinal beam structure at least in certain areas. The central region of the longitudinal beam structure can be structurally reinforced in this fashion. This reinforcement may furthermore prove advantageous, in particular, during a laterally offset frontal impact.

Due to the described longitudinal frame arrangement, foot well intrusions in the longitudinal direction of the vehicle can also be reduced and an improved load introduction or load distribution into the car body can be achieved in the longitudinal direction of the vehicle, particularly during a laterally offset frontal impact. The reinforcing structure makes it possible to achieve a load segmenting and branching of sorts, namely in that, referred to the longitudinal direction of the vehicle, the front longitudinal beam and the rear longitudinal beam are structurally connected to one another by means of the intermediate piece arranged in between, as well as the reinforcing structure.

Due to this branching and the additional structural connection between the front and the rear longitudinal beam by means of the reinforcing structure, the sheet thickness of involved car body components or car body components adjoining the longitudinal beam structure can be reduced. This reduction of the material thickness makes it possible to achieve an overall weight reduction of the longitudinal beam structure and therefore the entire car body despite the utilization of an additional reinforcing structure.

Although the following description merely refers to one front longitudinal beam, the car body typically features two lateral longitudinal beam structures that are realized symmetric to one another. It goes without saying that the description of the reinforcing structures and reinforcing elements refers to both longitudinal beams.

According to a first embodiment, the reinforcing structure features at least one first reinforcing element, a front end section of which borders on the front longitudinal beam, particularly on its rear end section referred to the driving direction of the motor vehicle. With its opposite end section, the first reinforcing element preferably extends outward referred to the lateral direction (y) of the vehicle in the form of an extension of the front longitudinal beam. In this respect, the first reinforcing element may act as a support of sorts for the front longitudinal beam or as a front frame support that, for example, borders on a vehicle dashboard or on a wheel housing sheet or wheel arch sheet and is structurally connected to such a sheet or similar adjoining car body components. Since the first reinforcing element extends outward referred to the lateral direction of the vehicle, it is possible to create a reinforcing structure that, referred to the lateral direction of the vehicle, lies outside the actual longitudinal beam structure and is particularly suitable for taking up and, if applicable, also absorbing laterally acting collision or impact forces.

According to an additional embodiment, the reinforcing structure furthermore features a beam extension that is arranged on the rear longitudinal beam or on a rear end section of the intermediate piece and extends forward facing the front longitudinal beam, wherein said beam extension is structurally connected to the front longitudinal beam by means of the first reinforcing element. Referred to the intermediate piece and referred to the rear longitudinal beam, the beam extension also extends outward in the driving direction, in particular, in order to stabilize and support the outwardly protruding end section of the first reinforcing element. The reinforcing structure advantageously features a second reinforcing element that connects the first reinforcing element to the beam extension. In this case, the second reinforcing element is designed, in particular, for structurally connecting the outwardly protruding end section of the first reinforcing element to a forwardly protruding end section of the beam extension.

In this context, it is proposed, in particular, that the first reinforcing element and/or that the beam extension is/are, referred to the vertical direction (z) of the vehicle, positioned in about the same plane as their assigned components of the longitudinal beam structure, particularly the front longitudinal beam and the rear longitudinal beam. Since the intermediate piece features a height offset between the front and the rear longitudinal beam, the second reinforcing element can likewise bridge the different heights of the adjoining components, namely between the first reinforcing element and the beam extension. In this case, it is furthermore advantageous if a section of the intermediate piece that is inclined relative to the longitudinal direction of the vehicle is arranged offset to the longitudinal position of the inclined second reinforcing element. In this way, a parallelogram-like and coherently designed reinforcing structure with improved torsional behavior can be provided.

In addition, the beam extension may have an L-shaped cross-sectional profile that corresponds to the cross-sectional profile of the frame extension and/or to the cross-sectional profile of the rear longitudinal beam in the region of its rear end section that faces away from the second reinforcing element. An L-shaped cross-sectional profile makes it possible to join corresponding profile sections to one another over a large surface. The profile sections may branch out; in this case diverge in the lateral direction of the vehicle along the driving direction of the vehicle, in order to form a reinforcing structure that is spaced apart from the intermediate piece in the lateral direction of the vehicle.

According to another embodiment, it is furthermore proposed that the first reinforcing element curves outward in the lateral direction of the vehicle in accordance with the contour of a wheel housing sheet. In this case, the first reinforcing element preferably extends in the x-y plane extending in the lateral and the longitudinal direction of the vehicle. Referred to the vertical direction (z) of the vehicle, the first reinforcing element remains at about the height of the front longitudinal beam in this respect.

Similarly, the beam extension that extends forward from the rear longitudinal beam and the rear end of the intermediate piece remains at about the height of the rear longitudinal beam that lies slightly lower than that of the front longitudinal beam. In this case, it would furthermore be possible to support the beam extension on a lateral structure on the side of the floor with an end section that lies in front referred to the driving direction of the vehicle, i.e., a front end section. The aforementioned lateral structure preferably extends between a lateral sill board and the intermediate piece in essentially the lateral direction (y) of the vehicle.

The lateral structure on the side of the floor is preferably arranged underneath or on bottom profile sections of the inner lateral sill board sheet and/or the intermediate piece and mounted thereon. It may furthermore be provided with so-called main receptacle bores in order to realize the mounting and positional fixing of the car body shell, as well as the transport thereof, during the course of the car body production process. In this respect, the aforementioned main receptacle bores form locating points for the car body at least during the production process.

According to another embodiment, the second reinforcing element has at least one surface section that is essentially realized plane and forms an oblique, upwardly extending resting platform, in particular, for a clutch foot of the vehicle occupant, preferably the driver. In this way, the second reinforcing element that acts as a structural node not only can fulfill its function of reinforcing the car body, but also a comfort function for the vehicle occupants. Consequently, a separate foot rest element or foot rest sheet can be eliminated.

In an additional development of this embodiment, the second reinforcing element features at least one flange section; preferably several flange sections, for being connected to adjoining car body components along its outer circumference. The peripheral flange sections make it possible to structurally connect the reinforcing element to all car body components surrounding the reinforcing element, particularly to the first reinforcing element, a wheel housing sheet, a floor sheet, a rear frame extension and an inner sill board sheet. Various connecting techniques commonly used in the construction of car bodies such as, for example, spot welding or laser welding, bonding, riveting or clinching may be universally utilized as connecting or joining techniques.

In an additional development of this embodiment, it is furthermore proposed that the intermediate piece of the longitudinal beam structure is realized in the form of, referred to the driving direction, an opposite extension of a front frame that is formed at least by the front longitudinal beam. This front frame extension is, referred to the lateral direction of the vehicle, arranged about in alignment with the longitudinal direction of the front longitudinal beam and/or the rear longitudinal beam and extends, referred to the vertical direction (z) of the vehicle, obliquely downward to the rear longitudinal beam at least in certain areas from its connection to the front longitudinal beam. Consequently, the front longitudinal beam and the rear longitudinal beam lie at a different height referred to the vertical direction (z) of the vehicle.

In an additional development, it is furthermore proposed that the first reinforcing element that acts, for example, as a support for the front longitudinal frame on the side of the dashboard is, referred to the vertical direction (z) of the vehicle, arranged at the height of the front longitudinal beam and/or the forwardly protruding beam extension of the rear longitudinal beam is arranged at the height of the rear longitudinal beam. Accordingly, it is proposed that the second reinforcing element bridges a height offset between the first reinforcing element and the beam extension or between the front longitudinal beam and the rear longitudinal beam similar to the intermediate piece to be provided between the front and the rear longitudinal beam.

According to an additional development, the intermediate piece furthermore may essentially have a U-shaped cross-sectional profile that is preferably closed by a floor sheet. It would additionally or alternatively also be possible for the intermediate piece to transform into an essentially L-shaped cross-sectional profile on at least one longitudinal end. The respective profile end therefore can adapt to an adjoining front and/or rear longitudinal beam and form a comparatively large overlapping region therewith. This large overlapping region makes it possible to mutually connect the center piece and the adjoining longitudinal beams as torsionally rigid as possible.

Furthermore, a motor vehicle with a car body of the above-described type is proposed. The car body preferably features two longitudinal beam structures that are separated from one another in the lateral direction of the vehicle and realized symmetric to one another.

### BRIEF DESCRIPTION OF THE FIGURES

The present invention will hereinafter be described in conjunction with the following drawing figures, wherein like numerals denote like elements, and:

FIG. 1 shows an isolated perspective representation of the longitudinal beam structure of a car body that is provided with a reinforcing structure in the dashboard region;

FIG. 2 shows another perspective representation of the beam and reinforcing structure from a different viewing angle;

FIG. 3 shows another perspective representation with a rear longitudinal beam;

FIG. 4 shows another representation of the longitudinal beam structure with an inner sill board sheet which corresponds to FIG. 1;

FIG. 5 shows a cross section A-A along the line of section illustrated in FIG. 1; and

FIG. 6 shows a horizontal cross section B-B along the line of section illustrated in FIG. 4.

### DETAILED DESCRIPTION

The following detailed description is merely exemplary in nature and is not intended to limit application and uses. Furthermore, there is no intention to be bound by any theory presented in the preceding background or summary or the following detailed description.

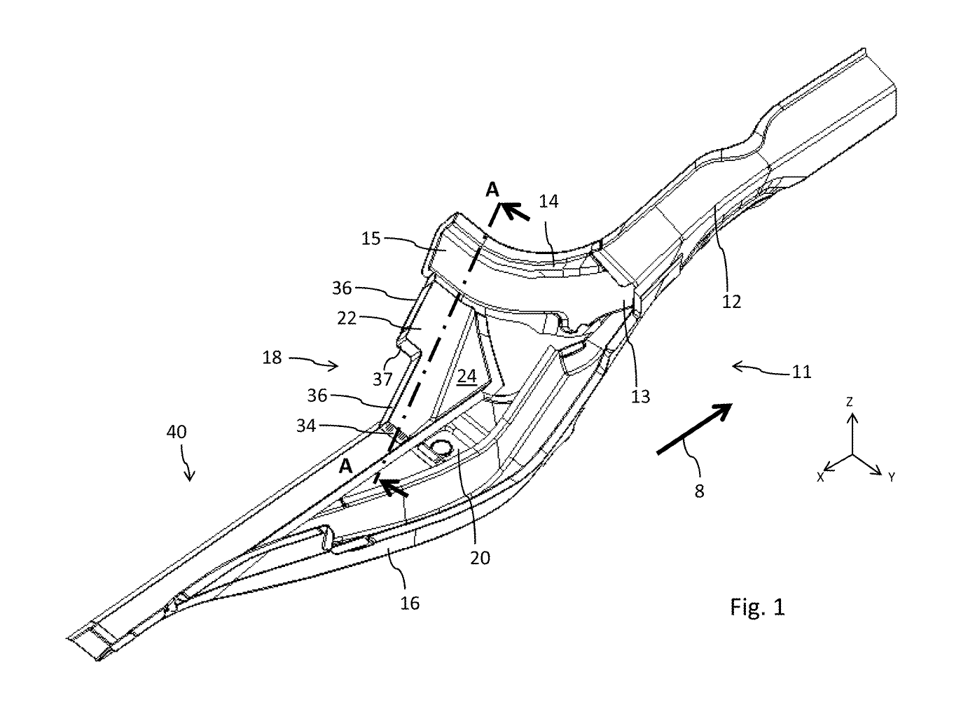

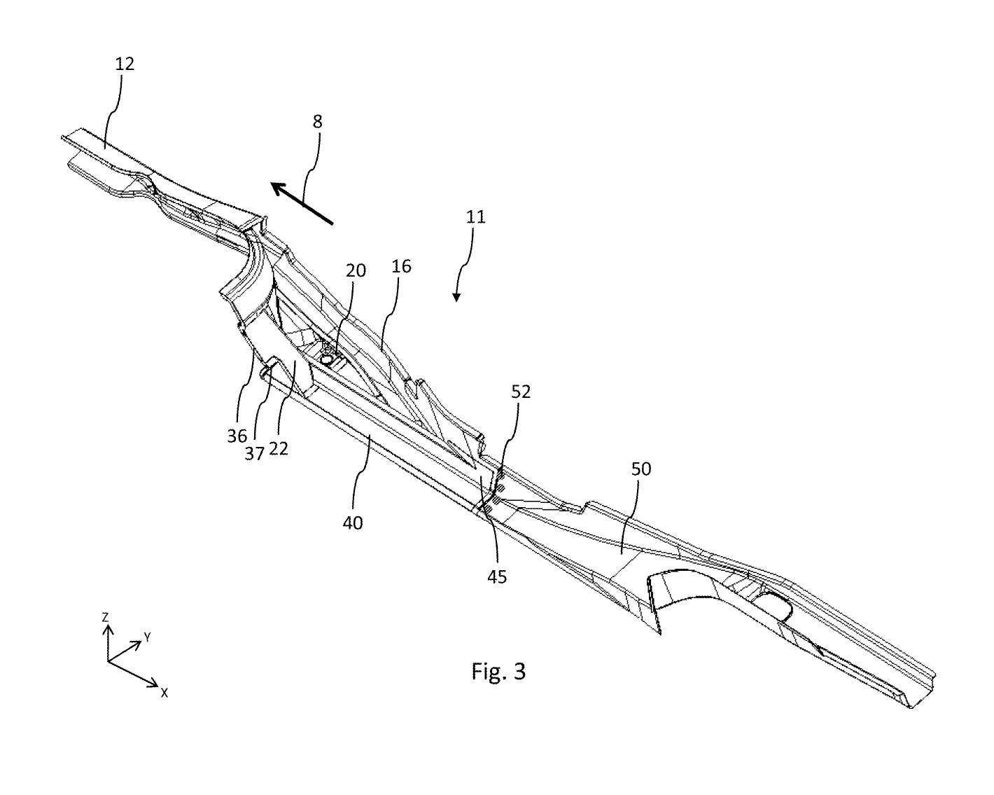

The section ally illustrated car body 10 in the perspective representations according to FIG. 1 to FIG. 4 features a longitudinal beam structure 11 that is composed of a front longitudinal beam 12, an intermediate piece 16 and a rear longitudinal beam 50 that is only illustrated in its entirety in FIG. 3. In addition to this longitudinal beam structure 11 that is formed by the three components front longitudinal beam 12, rear longitudinal beam 50 and intermediate piece or front frame extension 16, a reinforcing structure is provided that features a first reinforcing element 14, a second reinforcing element 18 and a beam extension 40.

The beam extension 40 is realized in the form of an essentially straight extension of a front end section of the rear longitudinal beam 50 and, referred to the driving direction 8, structurally connected to an outwardly protruding end section 15 of the first reinforcing element 14 with its front end section 47, namely by means of the second reinforcing element 18.

The front longitudinal beam 12 can be supported on a lateral dashboard, as well as on a wheel housing sheet 58, by means of the outwardly protruding reinforcing element 14. Similar to the first reinforcing element 14, the front longitudinal beam 12 may consist of a sheet metal profile realized with a C-shaped cross-sectional profile. A front end section 13 of the reinforcing element 14 that faces the front longitudinal beam 12 preferably corresponds to the cross-sectional profile of the longitudinal beam 12 in this case in order to form an overlapping region with the largest surface possible and thusly produce a structurally rigid connection between the longitudinal beam 12 and the reinforcing element 14.

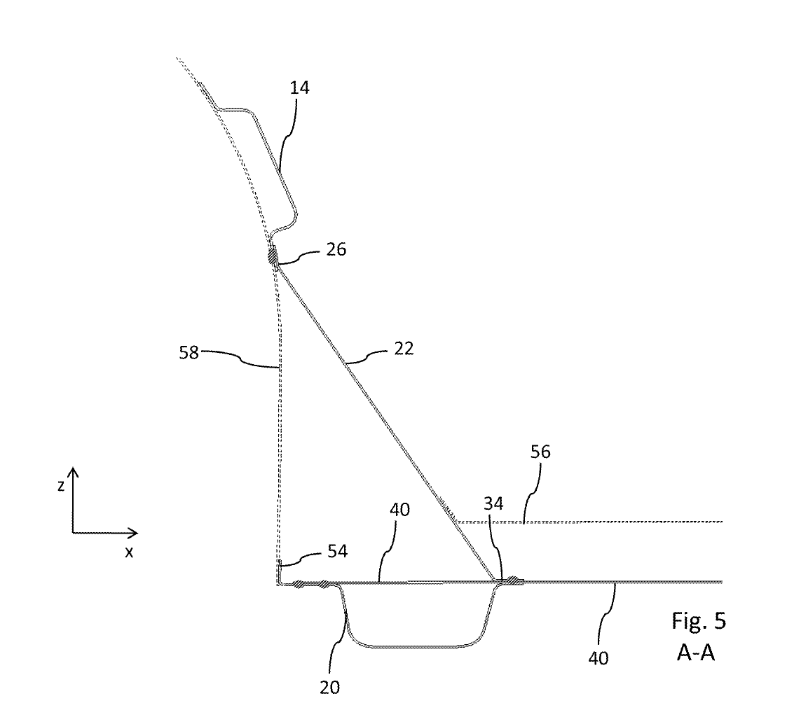

The first reinforcing element 14 acts as dashboard support of the front longitudinal beam 12 and curves outward in the lateral direction (y) of the vehicle in accordance with the contour of a wheel arch sheet 58 indicated, e.g., in FIG. 5. A reinforcing structure for the longitudinal beam structure 11 that quasi bridges the intermediate piece 16 can be realized with the aid of the second reinforcing element 18 that protrudes obliquely downward and rearward from the free end section 15 of the first reinforcing element 14.

The second reinforcing element 18 extends obliquely downward from the underside of the first reinforcing element 14 in the x-z plane, namely in the form of an essentially plane surface section 22, and protrudes toward a lower connecting flange of the first reinforcing element 14 with an upper connecting flange 26. Furthermore, the surface section 22 is supported on the beam extension 40 that protrudes forward in the driving direction 8 with a lower support or mounting flange 34 as illustrated in the cross section A-A in FIG. 5.

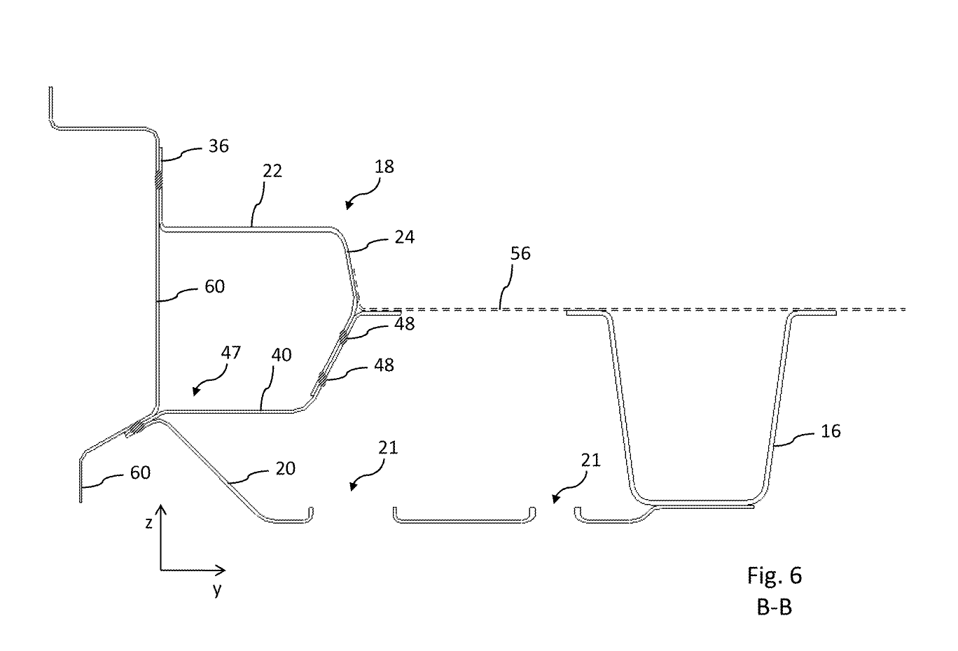

A floor sheet 56 is provided above the beam extension 40 and, according to the cross section in FIG. 6, simultaneously forms a closing element for an upwardly open, hat-shaped profile of the intermediate piece 16. The second reinforcing element 18 acts as a structural node and features another essentially plane lateral surface section 24 that essentially extends in the x-z plane and the surface normal of which is aligned essentially parallel to the lateral direction (y) of the vehicle.

The L-shaped or Z-shaped cross-sectional contour of the beam extension 40 is furthermore illustrated in the cross-sectional representation in FIG. 6. This beam extension supports an edge section of the floor sheet 56 and also serves for receiving and mounting the lateral surface section 24 of the second reinforcing element 18.

FIG. 6 furthermore shows that a cross member 20 on the side of the floor that features the main receptacle bores 21 is mounted on an inner sill board sheet 60 on the one hand and on the underside of the intermediate piece 16 on the other hand. Only a few spot welds 48 are illustrated in an exemplary fashion in FIG. 6, e.g., at the joints of the lateral surface section 24 and the beam extension 40, as well as in the overlapping region of the inner sill board sheet 60, the beam extension 40 and the cross member 20 on the side of the floor.

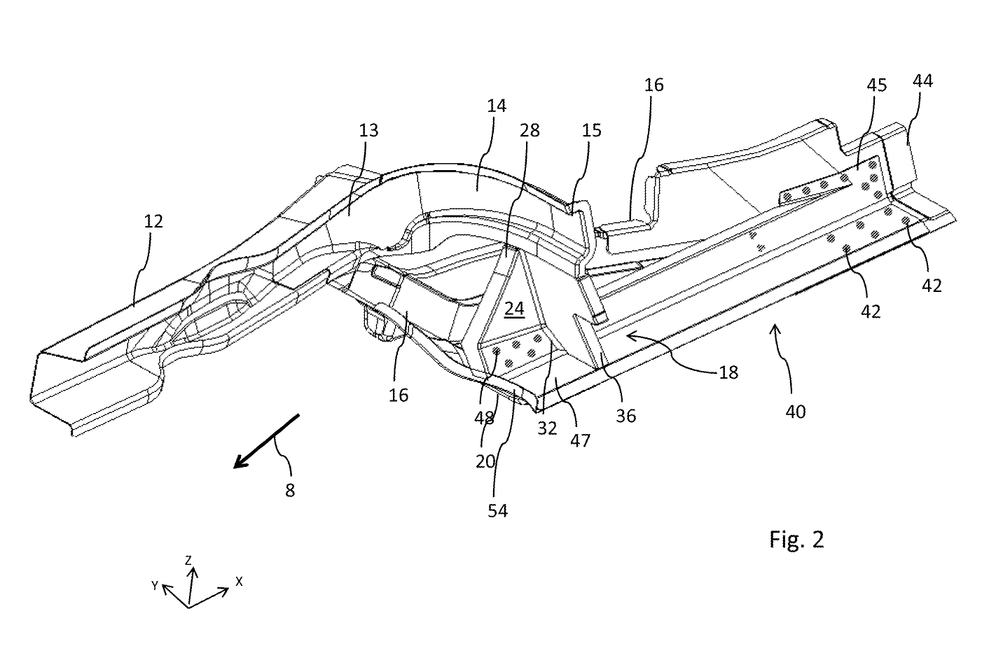

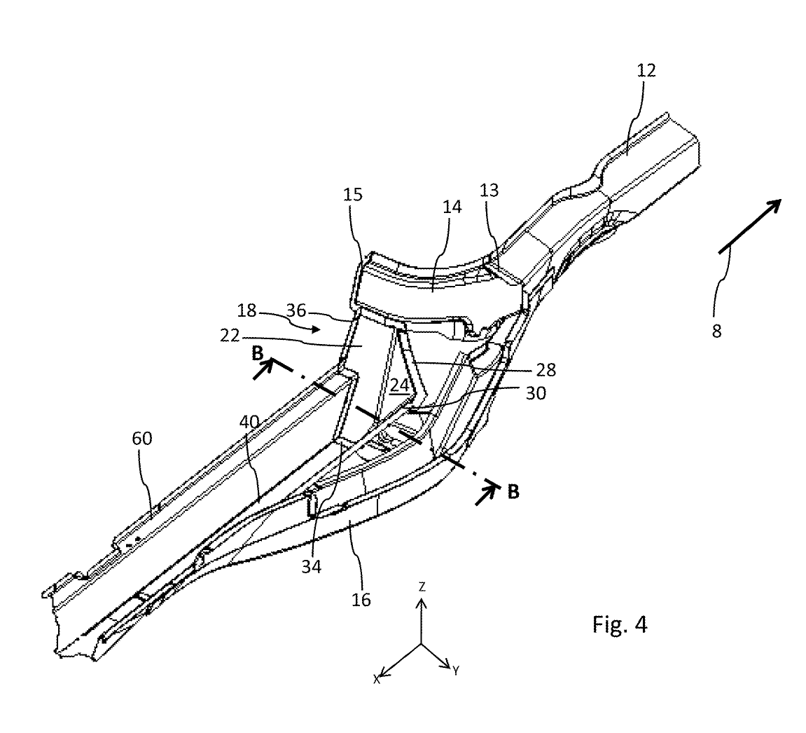

The cross member 20 features an upwardly protruding mounting flange 54 that faces a wheel arch sheet 58 as illustrated, for example, in FIG. 5 and indicated in FIG. 2. Furthermore, the synopsis of FIGS. 1 and 4 makes it possible to ascertain that the second reinforcing element 18 is supported on the box-shaped inner sill board sheet 60.

The outer lateral flange 36 of the reinforcing element 18 that essentially extends vertically or obliquely features an essentially horizontal pedestal piece 37 that that is positioned on the upper side of the inner sill board sheet 60 in the illustration according to FIG. 4 and preferably mounted at this location by means of a welded connection or by means of one of the cited alternative mounting techniques. The upper and lateral mounting flange 36 of the second reinforcing element 18 illustrated from another viewing angle in FIG. 2 is essentially positioned in alignment with a mounting flange that is arranged on the end of the first reinforcing element 14 and above the second reinforcing element. Once the final assembly configuration is reached, these flange sections are positioned on a lateral dashboard sheet that is not explicitly illustrated in the figures and structurally connected thereto in the flange region.

On the other end, i.e., on an end section that faces the intermediate piece 16, the second reinforcing element 18 features a mounting flange 28, by means of which the second reinforcing element 18 can be connected, e.g., to the wheel housing sheet 58 that is schematically illustrated with broken lines only in FIG. 5. The front end section of the beam extension 40 referred to the driving direction 8 is supported on the cross member 20 arranged thereunder, as well as on the inner side of the inner sill board sheet 60, as shown in FIG. 6. Furthermore, the first reinforcing element 14 that serves as an extension of the front longitudinal beam 12 can also be downwardly supported on the beam extension 40 by means of the second reinforcing element 18 such that the two reinforcing elements 14, 18 form a bridging for the intermediate piece 16 that structurally connects the front and rear longitudinal beams 12, 50 to one another together with the beam extension 40 that protrudes forward in the driving direction 8.

FIG. 2 furthermore shows that the beam extension 40 has an essentially L-shaped cross-sectional profile and therefore is positioned on the correspondingly realized L-shaped end section of the intermediate piece 16 with its two profile limbs. In this region, a plurality of mounting points or spot welds 42 are provided in order to produce a sufficiently rigid connection between the beam extension 40 and the intermediate piece 16, particularly in their overlapping region 45.

In the embodiment illustrated in FIG. 2, the rear receptacle region 44 on the side of the intermediate piece which is provided for receiving the rear longitudinal beam 50 protrudes at least slightly from the rear end of the beam extension 40. In this way, the rear longitudinal beam 50 can, for example, be connected to the intermediate piece 16 that is also referred to as a front frame extension by forming an overlapping region with the receptacle profile 44 only such that the rear longitudinal beam 50 and its forwardly protruding beam extension 40 quasi border on one another in a butt-jointed fashion.

Alternatively, it would naturally also be conceivable to mount the beam extension 40 on, referred to the driving direction 8, a front end section of the rear longitudinal beam 50. However, an effective bridging of the intermediate piece 16 is always achieved at least at, referred to the longitudinal direction (x) of the vehicle, the height of the first reinforcing element 14 with the embodiment illustrated in the figures, in which the beam extension 40 is mounted on an end section of the intermediate piece 16 that faces away from the driving direction 8 with its L-shaped cross-sectional profile.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A car body, comprising:
a longitudinal beam structure that extends in essentially a longitudinal direction of a vehicle and comprises:
a front longitudinal beam;
a rear longitudinal beam; and
an intermediate piece that structurally connects the rear longitudinal beam to the front longitudinal beam; and
a reinforcing structure connected to the longitudinal beam structure that bridges the intermediate piece, and referred to in a lateral direction of the vehicle, is arranged laterally offset to the longitudinal beam structure at least in an area.

2. The car body according to claim 1, wherein the reinforcing structure comprises a first reinforcing element that borders on the front longitudinal beam with a front end section and, referred to in the lateral direction of the vehicle, extends outward with an opposite end section.

3. The car body according to claim 2,
wherein the reinforcing structure comprises a beam extension that forwardly extends and is arranged on the rear longitudinal beam and faces the front longitudinal beam,
wherein said beam extension is connected to the front longitudinal beam with the first reinforcing element.

4. The car body according to claim 3, wherein the reinforcing structure comprises a second reinforcing element that connects the first reinforcing element to the beam extension.

5. The car body according to claim 4, wherein the beam extension that has an L-shaped cross-sectional profile that corresponds to a cross-sectional profile of a frame extension in a region of a rear end section that faces away from the second reinforcing element.

6. The car body according to claim 2, wherein the first reinforcing element is configured to curve outward in the lateral direction of the vehicle in accordance with a contour of a wheel housing sheet.

7. The car body according to claim 1,
wherein the forwardly extending beam extension is supported on a cross member on a side of a floor with, referred to in a driving direction of the vehicle, a front end section, and
wherein said cross member extends between a lateral sill board and the intermediate piece in essentially the lateral direction of the vehicle.

8. The car body according to claim 4, wherein the second reinforcing element comprises an essentially plane surface section that is realized as a resting platform extending obliquely upward in a driving direction of the vehicle.

9. The car body according to claim 4, wherein the second reinforcing element further comprises a plurality of flange sections connected to adjoining a car body component along an outer circumference.

10. The car body according to claim 1, wherein the intermediate piece is realized as, referred to in a driving direction, an opposite extension of a front frame.

11. The car body according to claim 1, wherein the front longitudinal beam and the rear longitudinal beam are configured to lie at a different height referred to a vertical direction of the vehicle.

12. The car body according to claim 2, wherein the first reinforcing element is, referred to in a vertical direction of the vehicle, arranged at a height of the front longitudinal beam is arranged at a second height of the rear longitudinal beam.

13. The car body according to claim 4, wherein the second reinforcing element comprises a height offset between the first reinforcing element and the beam extension and the rear longitudinal beam.

14. The car body according to claim 1, wherein the intermediate piece comprises a U-shaped cross-sectional profile.

15. The car body according to claim 1, wherein the intermediate piece transforms into an essentially L-shaped cross section on at least one longitudinal end.
